(19) United States
(12) Patent Application Publication
(10) Pub. No.: US 2026/0065829 A1
(43) Pub. Date: Mar. 5, 2026

(54) SOURCE DRIVER, DISPLAY APPARATUS AND DRIVING METHOD OF DISPLAY APPARATUS

(71) Applicant: Anapass Inc., Seoul (KR)

(72) Inventors: Chang Hwan KIM, Seoul (KR); Joon Bae PARK, Seoul (KR)

(21) Appl. No.: 19/311,256

(22) Filed: Aug. 27, 2025

(30) Foreign Application Priority Data
Aug. 28, 2024 (KR) 10-2024-0116170
Jul. 29, 2025 (KR) 10-2025-0103042

(51) Int. Cl. G09G 3/20

(52) U.S. Cl. CPC G09G 3/2074; G09G 2300/0804; G09G 2310/0267; G09G 2310/0286; G09G 2310/06; G09G 2320/0666; G09G 2330/023

(57) ABSTRACT

The present embodiment provides a display apparatus for displaying an image, the display apparatus comprising: a display panel including a plurality of pixels; a timing controller providing a digital signal corresponding to the image; and a source driver converting the digital signal into a grayscale signal which is an analog signal and providing the grayscale signal to the plurality of pixels, wherein the source driver comprises: a coarse driving amplifier providing the grayscale signal to a load connected to the source driver for coarse driving; a fine driving amplifier providing the grayscale signal to a load connected to the source driver for fine driving; and a multiplexer (MUX) multiplexing outputs of the coarse driving amplifier and the fine driving amplifier and outputting to the load.

### CROSS-REFERENCE TO RELATED APPLICATIONS

The present application claims priority to and the benefit of Korean Patent Application No. 10-2024-0116170, filed on Aug. 28, 2024 and Korean Patent Application No. 10-2025-0103042, filed on Jul. 29, 2025, the entirety of each of which are incorporated herein by reference.

### BACKGROUND

Present disclosure generally relates to source drivers, display apparatuses, and driving methods of display apparatuses.

### DESCRIPTION OF THE RELATED ART

Display apparatuses display images on display panels by providing pixel voltages to panel loads connected to source lines through source drivers that drive the display panels, and by providing scan signals through gate drivers. Source drivers form images on display panels by providing pixel voltages corresponding to digital image data provided by timing controllers to pixels included in the display panels through lines.

Displays are trending toward displaying high-resolution images at high speeds. However, panels capable of displaying high resolution have increased parasitic capacitance and increased parasitic resistance, making it difficult to display high-resolution images at high speeds.

The present disclosure aims to solve these difficulties of the prior art.

### SUMMARY

According to one aspect, there is provided a display apparatus for displaying an image, the display apparatus comprising: a display panel including a plurality of pixels; a timing controller providing a digital signal corresponding to the image; and a source driver converting the digital signal into a grayscale signal which is an analog signal and providing the grayscale signal to the plurality of pixels, wherein the source driver comprises: a coarse driving amplifier providing the grayscale signal to a load connected to the source driver for coarse driving; a fine driving amplifier providing the grayscale signal to a load connected to the source driver for fine driving; and a multiplexer (MUX) multiplexing outputs of the coarse driving amplifier and the fine driving amplifier and outputting to the load.

According to one aspect of the embodiment, an area of the fine driving amplifier is larger than an area of the coarse driving amplifier.

According to one aspect of the embodiment, the display apparatus includes a first channel, a second channel, and a third channel connecting the source driver to three pixels displaying three different colors, and operates by performing a cycle including a first period, a second period, a third period, and a scan period multiple times. In this aspect, when a first channel fine driving amplifier performs fine driving of the first channel in the first period, a second channel coarse driving amplifier performs coarse driving of the second channel. In this aspect, when a third channel fine driving amplifier performs fine driving of the third channel in the third period, a first channel coarse driving amplifier performs coarse driving of the first channel, and during the scan period, a result of the first channel coarse driving amplifier performing coarse driving of the first channel is maintained in the first channel.

According to one aspect of the embodiment, the first channel fine driving amplifier drives the first channel in the first period immediately after the scan period.

According to one aspect of the embodiment, the multiplexer is controlled by a control signal provided by the timing controller.

According to another aspect, there is provided a source driver converting a digital signal corresponding to an image into a grayscale signal which is an analog signal and providing the grayscale signal to a plurality of pixels, the source driver comprising: a coarse driving amplifier providing the grayscale signal to a load connected to the source driver for coarse driving; a fine driving amplifier providing the grayscale signal to a load connected to the source driver for fine driving; and a multiplexer (MUX) multiplexing outputs of the coarse driving amplifier and the fine driving amplifier and outputting to the load.

According to one aspect of the other embodiment, an area of the fine driving amplifier is larger than an area of the coarse driving amplifier.

According to one aspect of the other embodiment, the display apparatus includes a first channel, a second channel, and a third channel connecting the source driver to three pixels displaying three different colors, and operates by performing a cycle including a first period, a second period, a third period, and a scan period multiple times. In this aspect, when a first channel fine driving amplifier performs fine driving of the first channel in the first period, a second channel coarse driving amplifier performs coarse driving of the second channel. Also, in this aspect, when a third channel fine driving amplifier performs fine driving of the third channel in the third period, a first channel coarse driving amplifier performs coarse driving of the first channel, and during the scan period, a result of the first channel coarse driving amplifier performing coarse driving of the first channel is maintained in the first channel.

According to one aspect of the other embodiment, the first channel fine driving amplifier drives the first channel in the first period immediately after the scan period.

According to one aspect of the other embodiment, the multiplexer is controlled by a control signal provided by a timing controller.

According to yet another aspect, there is provided a driving method of a display apparatus, the driving method comprising: a first step in which a source driver performs fine driving of a first channel connected to a pixel displaying a first color and performs coarse driving of a second channel displaying a second color; a second step in which the source driver performs fine driving of the second channel and performs coarse driving of a third channel displaying a third color; and a third step in which the source driver performs fine driving of the third channel and performs coarse driving of the first channel.

According to one aspect of the yet another embodiment, the driving method of the display apparatus further comprises a scan step of displaying on the display results of fine driving performed in the first step, the second step, and the third step. In this aspect, the first step, the second step, the third step, and the scan step are performed sequentially. In this aspect, the source driver includes coarse driving amplifiers and fine driving amplifiers for each channel, wherein coarse driving of each step is performed by the coarse driving amplifier and fine driving is performed by the fine driving amplifier.

### BRIEF DESCRIPTION OF THE DRAWINGS

FIG. 1 is a diagram illustrating an overview of a display apparatus according to the present embodiment.

FIG. 2 is a block diagram illustrating a source driver that provides pixel data provided from a timing controller to a display panel.

FIG. 3 is a diagram illustrating an overview of a driving unit of the present embodiment.

FIG. 4 is a diagram schematically illustrating voltage waveforms when driving a source line of a target driving channel with the driving unit of the present embodiment and when driving with conventional technology.

FIG. 5 is a flowchart illustrating an example in which coarse driving amplifier and fine driving amplifier drive a source line to have a desired voltage.

FIG. 6 is a diagram schematically illustrating source line voltages in a display apparatus displaying a plurality of different colors according to the present embodiment.

### DETAILED DESCRIPTION OF THE EMBODIMENTS

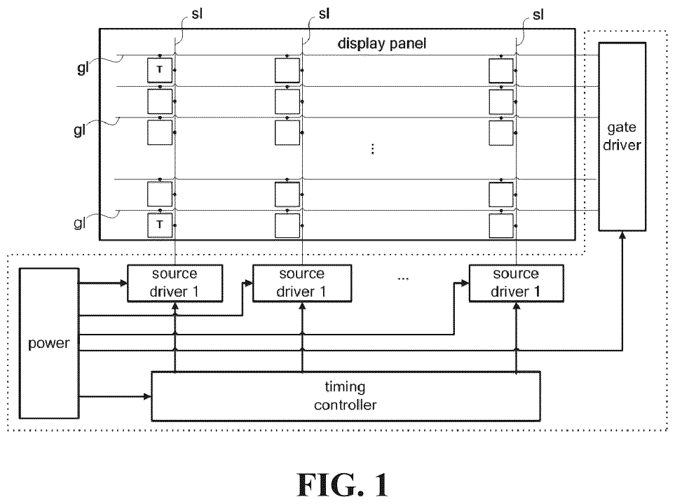

Hereinafter, the present embodiment will be described with reference to the accompanying drawings. FIG. 1 is a diagram illustrating an overview of a display apparatus according to the present embodiment. Referring to FIG. 1, the display apparatus according to the present embodiment includes a display panel, a gate driver, and a source driver 1, and includes a timing controller that provides image data to be displayed by the display system and changes characteristics of screen sources applied from outside or adjusts driving timing according to resolution and characteristics. Depending on characteristics of the display panel, the timing controller and the source driver 1 may be formed as separate chips, or as illustrated in the drawing, the timing controller and the source driver 1 may be implemented as one chip.

The display panel includes a plurality of pixels T including R pixels, G pixels, and B pixels, and each pixel T is connected to a gate driver through a gate line gl and electrically connected to the source driver 1 through a source line sl. The source driver 1 drives by charging grayscale signals that each pixel T should display to source lines sl connected to the pixels, and the gate driver provides scan signals through gate lines to cause the display to display images.

The source line sl connecting the source driver 1 and the pixel T is composed of conductive lines, and various parasitic capacitances exist including resistance components of the conductive lines, parasitic capacitance between adjacent lines, and parasitic capacitance with reference electrodes, forming RC time constants. These loads and switches such as thin film transistors in pixels can be modeled as resistance-capacitor pairs (RC pairs). That is, the load that the source driver must drive has a distributed resistance-capacitance (distributed RC) configuration.

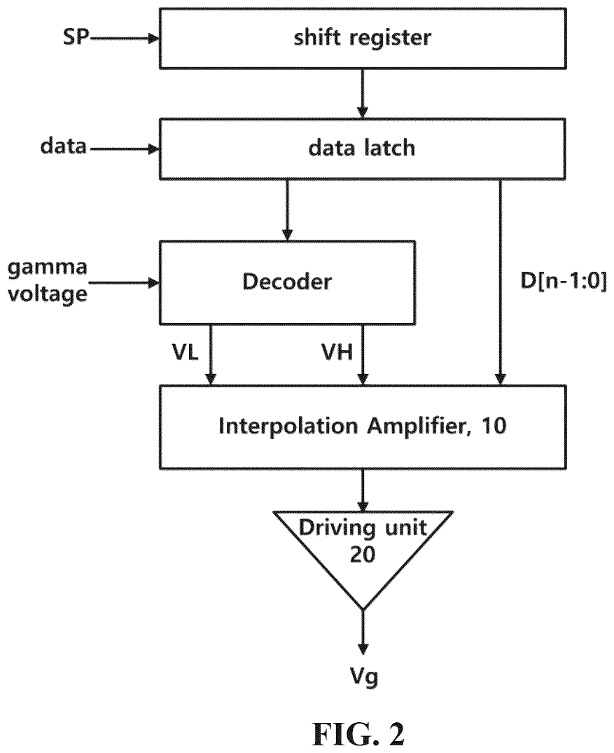

FIG. 2 is a block diagram illustrating the source driver 1 that provides pixel data provided from a timing controller (refer to FIG. 1) to the display panel 100. Referring to FIG. 2, signals provided to the display panel pass through a shift register, data latch, sample/hold register (S/H register), decoder, digital-to-analog converter (DAC), and interpolation amplifier before being provided to pixels of the display panel.

The shift register sequentially shifts and outputs an input start pulse SP. The data latch latches up and provides image data. In one embodiment, the data latch may include a sample/hold register (S/H register) that samples the latched-up image signal according to the start pulse SP and holds and provides the sampled data.

The decoder, for example, receives a plurality of gamma voltages and pixel data, selects an upper voltage VH and a lower voltage VL from the gamma voltages to correspond to the pixel data, and outputs them to an interpolation amplifier. The interpolation amplifier 10 receives the upper voltage VH, lower voltage VL, and pixel data D[n-1:0], and interpolates and outputs a voltage between the upper voltage VH and lower voltage VL to correspond to the provided pixel data D[n−1:0]. The driving unit 20 drives the load with the grayscale voltage output by the interpolation amplifier 10.

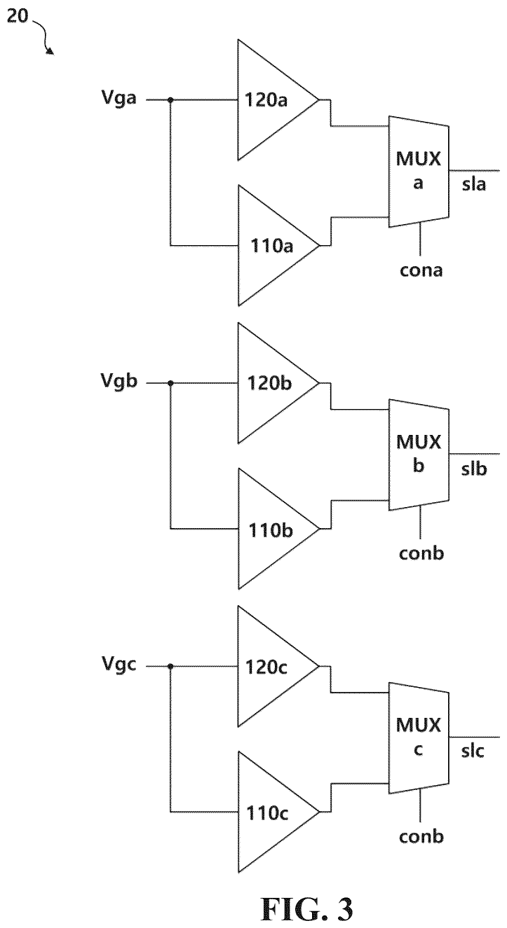

FIG. 3 is a diagram illustrating an overview of the driving unit 20 of the present embodiment. Referring to FIGS. 1 to 3, the driving unit 20 of the present embodiment includes a coarse driving amplifier 110 that performs coarse driving of the load, a fine driving amplifier 120 that provides grayscale signals to the load for fine driving, and a multiplexer (MUX) that multiplexes outputs of the coarse driving amplifier 110 and the fine driving amplifier 120 and outputs to the load.

In the illustrated embodiment, the source driver 1 includes a coarse driving amplifier 110a and a fine driving amplifier 120a that are connected to and drive a source line sla connected to a pixel displaying any one color among R, G, and B, and a multiplexer MUXa that is controlled by a control signal provided by the timing controller and outputs either one of the output signals of the coarse driving amplifier 110a and the fine driving amplifier 120a. Similarly, the driving unit 20 includes a coarse driving amplifier 110b and a fine driving amplifier 120b that are connected to and drive a source line slb connected to another pixel among R, G, and B, and a multiplexer MUXb that is controlled by a control signal provided by the timing controller and outputs either one of the output signals of the coarse driving amplifier 110b and the fine driving amplifier 120b.

The source driver 1 includes a coarse driving amplifier 110c and a fine driving amplifier 120c that are connected to and drive a source line slc connected to yet another pixel among R, G, and B, and a multiplexer MUXc that is controlled by a control signal provided by the timing controller and outputs either one of the output signals of the coarse driving amplifier 110c and the fine driving amplifier 120c.

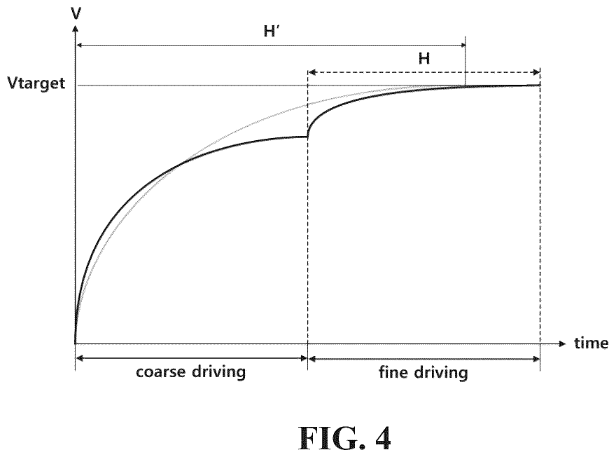

FIG. 4 is a diagram schematically illustrating voltage waveforms when driving a source line of a target driving channel with the driving unit 20 of the present embodiment and when driving with conventional technology. The source driver drives by charging voltages corresponding to grayscales output by respective pixels to source lines sl. The pixels T display grayscales corresponding to voltages charged to source lines sl according to scan signals of the gate driver. When a conventional source driver drives by charging a source line of a target driving channel to a desired grayscale voltage, the speed of rising to a desired voltage Vtarget is limited by the time constant value of the source line (refer to gray solid line).

However, in the present embodiment shown by the black solid line, when a fine driving amplifier connected to another channel performs fine driving of that channel, a coarse driving amplifier connected to the target driving channel performs coarse driving of the target driving channel so that the source line of that channel quickly reaches the desired voltage Vtarget.

Subsequently, the fine driving amplifier connected to the target driving channel performs fine driving of the target driving channel to charge and drive the source line to the desired voltage. The fine driving amplifier performs fine driving of the source line sl so that the source line sl driven by the coarse driving amplifier can be charged to the desired voltage.

In conventional technology, when driving a source line to a desired voltage Vtarget with a single amplifier, time H′ was consumed as shown by the gray line. However, according to the present embodiment, while fine driving another source line, the source line is pre-driven by the coarse driving amplifier 110. Subsequently, the fine driving amplifier 120 performs fine driving to the desired voltage Vtarget.

When the fine driving amplifier 120 performs fine driving of the source line as in the present embodiment, the time consumed is H. According to the present embodiment, the time consumed for coarse driving of one source line can be hidden by the fine driving time of another source line, ultimately reducing the exposed driving time of the source line to H.

In one embodiment, the size of transistors included in the current driving stage of the coarse driving amplifier 110 may be larger than or equal to the size of transistors included in the current driving stage of the fine driving amplifier 120. Therefore, the current output by the coarse driving amplifier 110 may be larger than or at least equal to the current that the fine driving amplifier 120 can provide.

However, the overall area of the fine driving amplifier is larger than the overall area of the coarse driving amplifier. That is, transistors included in the control stage that controls the current driving stage of the coarse driving amplifier 110 may have small sizes to control transistors included in the current driving stage with sufficient accuracy. However, the coarse driving amplifier 110 may have errors from the desired grayscale voltage but can quickly bring the source line sl to the grayscale voltage Vg.

For example, the fine driving amplifier can perform fine driving of channels with precision of offset of 10 mV or less. However, since the control stage of the coarse driving amplifier consists of small-sized transistors, it can roughly drive channels with lower precision than the precision of the fine driving amplifier. In one embodiment, the offset of the coarse driving amplifier may be 50 mV or less. Therefore, power consumption of the source driver and display apparatus can be reduced, and economic efficiency during manufacturing can be improved.

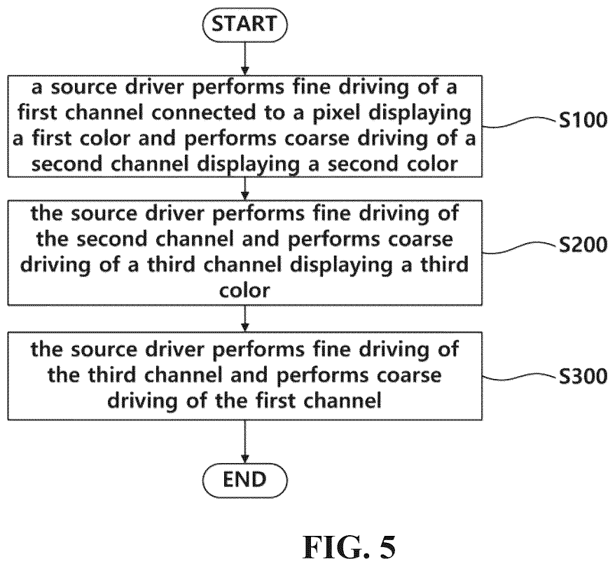

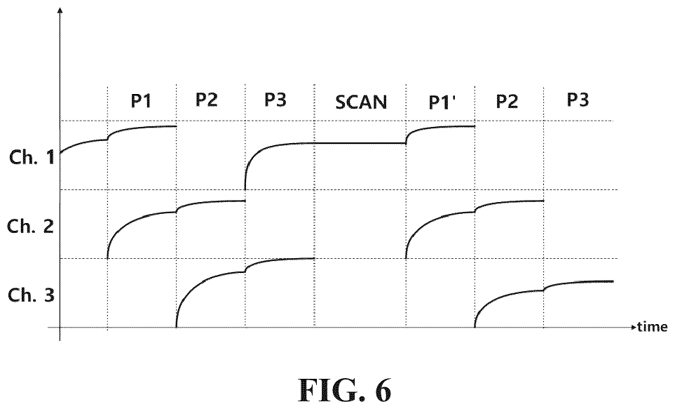

FIG. 5 is a flowchart illustrating an example in which the coarse driving amplifier 110 and fine driving amplifier 120 drive a source line to have a desired voltage, and FIG. 6 is a diagram schematically illustrating source line voltages in a display apparatus displaying a plurality of different colors according to the present embodiment. Referring to FIGS. 1 to 6, the driving method of the display apparatus according to the present embodiment comprises: a first step S100 in which the source driver 1 performs fine driving of a first channel connected to a pixel displaying a first color and performs coarse driving of a second channel displaying a second color; a second step S200 in which the source driver 1 performs fine driving of the second channel and performs coarse driving of a third channel displaying a third color; and a third step S300 in which the source driver 1 performs fine driving of the third channel and performs coarse driving of the first channel.

The present embodiment performs coarse driving of a second channel connected to a second pixel displaying a second color by a coarse driving amplifier 110b connected to the second channel during a period P1 when a fine driving amplifier 120a connected to the first channel included in the source driver 1 performs fine driving of the first channel connected to a pixel displaying the first color (S100). During a period P2 when a fine driving amplifier 120b connected to the second channel performs fine driving of the second channel connected to a pixel displaying the second color, a coarse driving amplifier 110c connected to the third channel performs coarse driving of the third channel connected to a third pixel displaying the third color (S200). Subsequently, during a period P3 when a fine driving amplifier 120c connected to the third channel performs fine driving of the third channel connected to a pixel displaying the third color, a coarse driving amplifier 110a connected to the first channel performs coarse driving of the first channel connected to the first pixel displaying the first color (S300).

From this driving method, the coarse driving time of one channel can be hidden by the fine driving time of another channel, providing the advantage of being able to display higher resolution images at high speed.

In one embodiment, in the scan period SCAN, pixels display grayscales corresponding to charged voltages. However, in the first channel (Ch. 1) driving period P1′ after the scan period SCAN, fine driving that can hide the time for coarse driving of the first channel in the scan period SCAN does not precede. Therefore, the coarse driving amplifier 110a performs coarse driving of the first channel during the third channel fine driving period P3 before the scan period SCAN and maintains the driving result during the scan period SCAN. The fine driving amplifier 110b connected to the first channel performs fine driving of the first channel (Ch. 1) to the desired voltage in the subsequent first channel driving period P1′.

However, in other embodiments not shown, the first channel may be driven by a single amplifier, and in such embodiments, the amplifier may drive the first channel to the desired voltage during the period when driving the first channel after the scan period SCAN.

In the present embodiment, since the coarse driving period of source lines by coarse driving amplifiers included in the driving unit can be hidden in the fine driving periods of source lines by fine driving amplifiers connected to other source lines, the advantage of being able to display images at high speed is provided.

Although described with reference to embodiments shown in the drawings to aid understanding of the present invention, these are examples for implementation and are merely illustrative, and those skilled in the art will understand that various modifications and equivalent other embodiments are possible therefrom. Therefore, the true technical protection scope of the present invention should be determined by the appended claims.

What is claimed is:

1. A display apparatus for displaying an image, the display apparatus comprising:
a display panel including a plurality of pixels;
a timing controller providing a digital signal corresponding to the image;
a source driver converting the digital signal into a grayscale signal which is an analog signal and providing the grayscale signal to the plurality of pixels, wherein the source driver comprises:
a coarse driving amplifier providing the grayscale signal to a load connected to the source driver for coarse driving;
a fine driving amplifier providing the grayscale signal to a load connected to the source driver for fine driving; and
a multiplexer (MUX) multiplexing outputs of the coarse driving amplifier and the fine driving amplifier and outputting to the load.

2. The display apparatus of claim 1,
wherein an area of the fine driving amplifier is larger than an area of the coarse driving amplifier.

3. The display apparatus of claim 1,
wherein the display apparatus includes a first channel, a second channel, and a third channel connecting the source driver to three pixels displaying three different colors, and
operates by performing a cycle including a first period, a second period, a third period, and a scan period multiple times.

4. The display apparatus of claim 3,
wherein when a first channel fine driving amplifier performs fine driving of the first channel in the first period,
a second channel coarse driving amplifier performs coarse driving of the second channel.

5. The display apparatus of claim 3,
wherein when a third channel fine driving amplifier performs fine driving of the third channel in the third period,
a first channel coarse driving amplifier performs coarse driving of the first channel, and
during the scan period, a result of the first channel coarse driving amplifier performing coarse driving of the first channel is maintained in the first channel.

6. The display apparatus of claim 1,
wherein the first channel fine driving amplifier drives the first channel in the first period immediately after the scan period.

7. The display apparatus of claim 1,
wherein the multiplexer is controlled by a control signal provided by the timing controller.

8. A source driver converting a digital signal corresponding to an image into a grayscale signal which is an analog signal and providing the grayscale signal to a plurality of pixels, the source driver comprising:
a coarse driving amplifier providing the grayscale signal to a load connected to the source driver for coarse driving;
a fine driving amplifier providing the grayscale signal to a load connected to the source driver for fine driving; and
a multiplexer (MUX) multiplexing outputs of the coarse driving amplifier and the fine driving amplifier and outputting to the load.

9. The source driver of claim 8,
wherein an area of the fine driving amplifier is larger than an area of the coarse driving amplifier.

10. The source driver of claim 8,
wherein the display apparatus includes a first channel, a second channel, and a third channel connecting the source driver to three pixels displaying three different colors, and
operates by performing a cycle including a first period, a second period, a third period, and a scan period multiple times.

11. The source driver of claim 10,
wherein when a first channel fine driving amplifier performs fine driving of the first channel in the first period,
a second channel coarse driving amplifier performs coarse driving of the second channel.

12. The source driver of claim 10,
wherein when a third channel fine driving amplifier performs fine driving of the third channel in the third period,
a first channel coarse driving amplifier performs coarse driving of the first channel, and
during the scan period, a result of the first channel coarse driving amplifier performing coarse driving of the first channel is maintained in the first channel.

13. The source driver of claim 8,
wherein the first channel fine driving amplifier drives the first channel in the first period immediately after the scan period.

14. The source driver of claim 8,
wherein the multiplexer is controlled by a control signal provided by a timing controller.

15. A driving method of a display apparatus, the driving method comprising:
a first step in which a source driver performs fine driving of a first channel connected to a pixel displaying a first color and performs coarse driving of a second channel displaying a second color;
a second step in which the source driver performs fine driving of the second channel and performs coarse driving of a third channel displaying a third color; and
a third step in which the source driver performs fine driving of the third channel and performs coarse driving of the first channel.

16. The driving method of the display apparatus of claim 15,
further comprising a scan step of displaying on the display results of fine driving performed in the first step, the second step, and the third step.

17. The driving method of the display apparatus of claim 16,
wherein the first step, the second step, the third step, and the scan step are performed sequentially.

18. The driving method of the display apparatus of claim 16,
wherein the source driver includes coarse driving amplifiers and fine driving amplifiers for each channel,
wherein coarse driving of each step is performed by the coarse driving amplifier and fine driving is performed by the fine driving amplifier.
